(19) United States
(12) Patent Application Publication
(10) Pub. No.: US 2003/0059278 A1
(43) Pub. Date: Mar. 27, 2003

(54) Rivet with circular recess

(75) Inventor: Shinichi Kochiya, Tokyo (JP)

Correspondence Address: WOOD, PHILLIPS, KATZ, CLARK & MORTIMER, 500 W. MADISON STREET, SUITE 3800, CHICAGO, IL, 60661, US

(73) Assignee: YKK Corporation.

(21) Appl. No.: 10/253,150

(22) Filed: Sep. 24, 2002

(30) Foreign Application Priority Data
Sep. 26, 2001 (JP) 2001-293228

(51) Int. Cl. F16B 19/00

(52) U.S. Cl. 411/508

(57) ABSTRACT

A rivet member comprising a flange part (12) and a shank part (16) protruding upright from the flange part, with a circular recess (18) formed on the inner side (14) of the flange, which is used in combination with a burr member (5, 5′, or 7) having a barrel (13, 13′, or 15) of a desired shape, the circular recess (18) being adapted to receive the barrel that has pierced through a fabric or other sheet material (11) or to receive the barrel with the sheet material interposed between the bottom of barrel and the flange of the sheet. This arrangement overcomes the problem of formation of gaps between the flanges of the rivet and the barrel of the burr member.

### BACKGROUND OF THE INVENTION

This invention relates to a rivet member for use with a burr member to be clinched through a fabric or other similar sheet material so as to be secured in position.

Conventional rivet members to be clinched with a burr member through a fabric or other sheet material include, for example, those shown at (a), (b), and (c) in FIG. 3 of the accompanying drawings. The first one at (a) is a combination of a shank part 1 and a flange part 3 radially extended around the shank, the two parts being made separately and assembled together. The other two, (b) and (c), respectively, have both a shank part 1′ or 1″ and a flange part 3′ or 3″ made in one piece.

Those rivet members (a), (b), and (c) illustrated in FIG. 3 are designed to be secured in such a way that each rivet member is forced through a fabric or other sheet material into a burr member 5, 5′, or 7 located on the opposite side of the material and indicated, for example, at (i), (ii), or (iii), respectively, in FIG. 4, and then a predetermined clinching pressure is applied so as to secure the two members firmly with the material.

The rivet members shown at (a), (b), and (c) in FIG. 3 and the burr members 5, 5′, and 7 shown at (i), (ii), and (iii) in FIG. 4 are in most cases made of relatively soft and plastically deformable metal materials, such as aluminum and copper. Meanwhile the flat portion on the inner or outer side of the flange part of the rivet member is often sloped or curved as desired, as at symbol “e” or “f”, to achieve a certain design effect or decorative purpose.

In FIG. 5 is illustrated an example of riveting where, as described above, a rivet member 9 is forced through a fabric or other sheet material 11 into a burr member 5 and then a predetermined clinching pressure is applied to the shank part 1 of the rivet member 9 so as to form a head in the hollow of the burr member and secure the rivet to the material 11.

When a conventional burr member, especially the member 5, 5′, or 7 designated (i), (ii), or (iii) in FIG. 4 that has a comparatively long barrel 13, 13′, or 15 protruding toward the rivet member is used, it often occurs with a thin fabric or sheet material 11 to which the rivet member and burr member are secured that relatively large gaps as represented by symbols hl and h2 in FIG. 5 are left after riveting between the material 11 and the inner flange surface 17 of the rivet member and the inner flange surface 19 of the burr member.

Such gaps can catch other sheet material portion or string or the like, sometimes leading to great danger.

The large gaps that result from riveting of conventional rivet members to thin sheet materials have presented a problem. The present invention has for its object to provide a rivet member capable of minimizing those gaps and hence the danger of the gaps catching other sheet material portion, string, or the like.

### SUMMARY OF THE INVENTION

In accordance with the present invention, a rivet member is provided which comprises a flange part and a shank part protruding upright from the flange part, with a circular recess formed on the inner side of the flange.

In an embodiment of the invention the rivet member is used in combination with a burr member having a barrel of a desired shape and the circular recess is adapted to receive the barrel that has passed through a sheet material or to receive the barrel with the sheet material interposed between the bottom of barrel and the flange of the sheet.

In another embodiment of the invention the rivet member may comprise the parts formed in one piece.

In still another embodiment the circular recess is formed with a single or a plurality of protrusions along the outer circumference of the recess.

### BRIEF EXPLANATION OF THE DRAWINGS

FIG. 1 is a perspective view of a rivet member having a circular recess formed on the inner side of its flange in accordance with the present invention;

FIG. 2 is a sectional side view of the rivet member of FIG. 1, showing the circular recess formed on the inner side of the flange;

FIG. 3 (a) is a partially sectional side view of a conventional rivet member; FIG. 3(b) is a partially sectional side view of another conventional rivet member; and FIG. 3(c) is a partially sectional side view of still another conventional rivet member;

FIG. 4 (i) is a sectional side view of a burr member; FIG. (ii) is a sectional side view of another burr member; and FIG. (iii) is a sectional side view of yet another burr member; and

FIG. 5 is a sectional side view of a burr member and a rivet member as riveted together through a fabric or other sheet material.

### DETAILED DESCRIPTION OF THE INVENTION

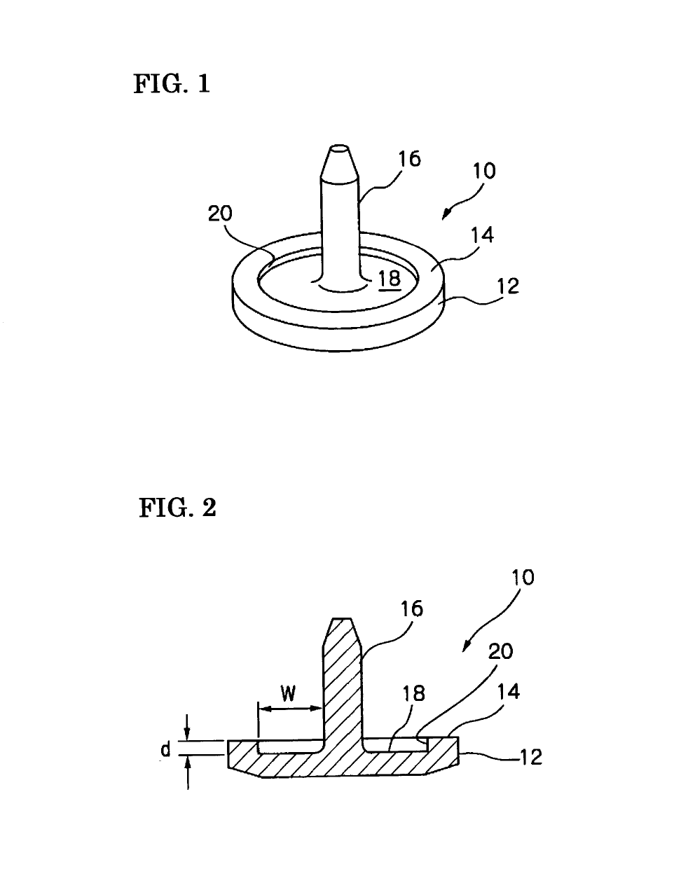

The invention will now be more fully described with reference to FIGS. 1 and 2.

FIG. 1 shows in perspective a rivet member 10 according to the invention.

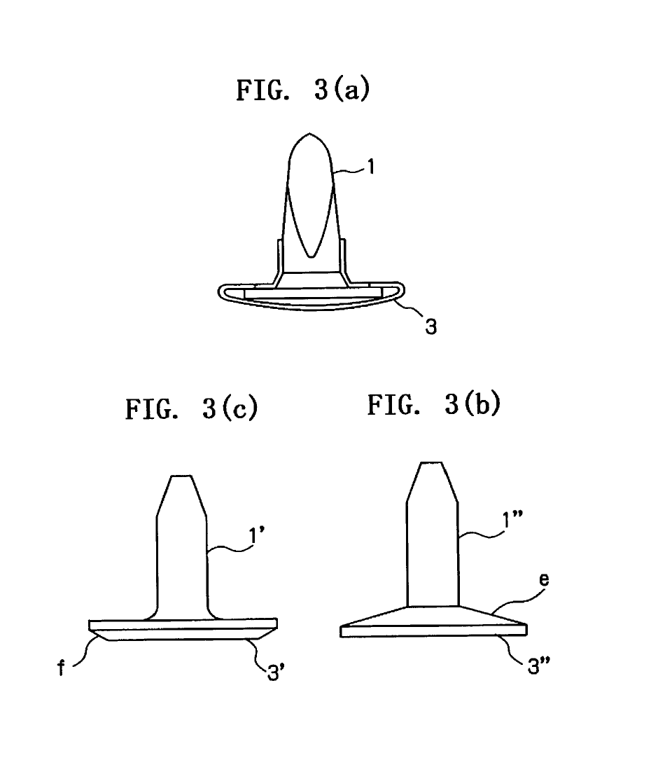

The rivet member 10 is of the same type as the conventional product designated (c) in FIG. 3. It comprises a flange part 12 and an upright shank part 16 of a given height located in the center of the inner side 14 of the flange part 12, in one piece with the flange.

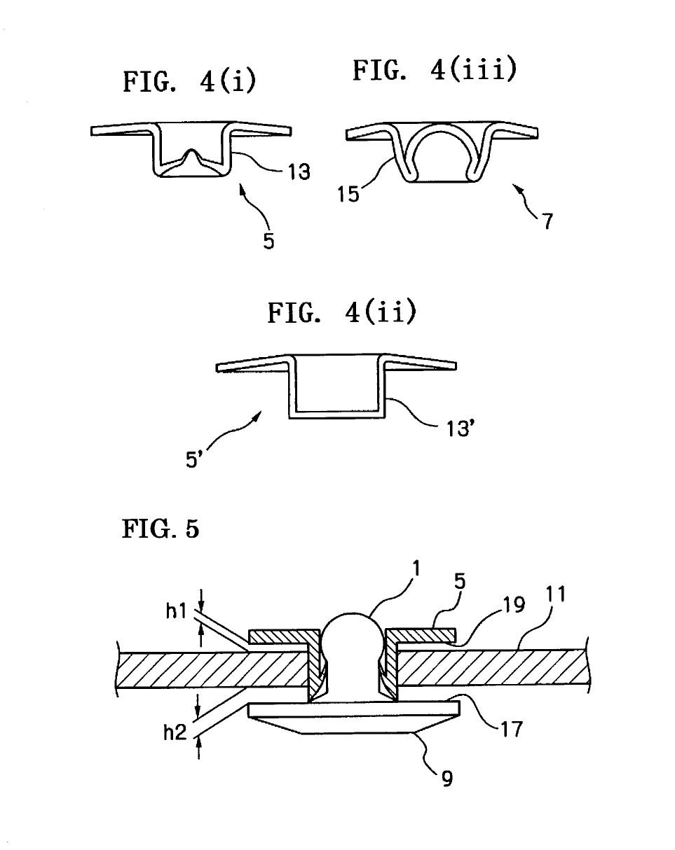

The rivet member 10 of the present invention too is made usually from a relatively soft, plastically deformable metal material such as aluminum or copper. For riveting use, it is located on a side of a fabric or other sheet material opposite to a burr member 5 or 7 of a concave bottom as indicated at (i) or (iii) or a burr member 5′ of a flat bottom shown at (ii) in FIG. 4. The rivet member is then pressed through the sheet material into the burr member and, under a predetermined clinching pressure, the two members are riveted together fast to the sheet material.

Under the invention the rivet member 10 is further formed with a circular recess indicated by numeral 18 in part of the inner side 14 of the flange. The circular recess 18 extends around the shank part 16, with a predetermined depth d from the remainder of the inner side of the flange 14 and a predetermined width w corresponding to the dimensions of the barrel of the burr member.

As the shank part 16 of the rivet member 10 is forced through a fabric or other sheet material into the burr member 5, 5′, or 7 located on the opposite side of the material and the two members are riveted together, the circular recess 18 can receive the periphery of the bottom of the barrel 13 or 15 of the burr member 5 or 7 or part of the flat bottom of the barrel 13′ of the burr member 5′ with the fabric interposed between the flange of the rivet and the bottom of the barrel.

The arrangement makes it possible to reduce, by the depth d of the circular recess, the relatively large gaps indicated at h1 and h2 in FIG. 5 that otherwise result from the riveting of a rivet member (a), (b), or (c) of FIG. 3 with the burr member, between the inner side 19 of the flange of the burr member and the inner side 17 of the flange of the rivet member. Consequently, the danger of those gaps catching some other sheet material portion, string or the like can be reduced to a minimum.

Needless to say, the depth d and the width w of the circular recess should be chosen from the ranges in which sufficient mechanical strength is maintained to protect the flange part 12 from being deformed by the mechanical pressure that is applied when the rivet member is forced into the burr member and then riveted to the sheet material.

While the present invention has been described in its preferred embodiment, it is to be understood that various changes and modifications may be made without departing from the spirit and scope of the invention.

By way of example, the afore-described embodiment uses a rivet member of the same type as the conventional one (c) of FIG. 3. Unless the adequate mechanical strength of the flange part 12 as defined above is impaired, it is also possible to employ other types of rivet members that are thick enough to form a circular recess 18 on the inner side, such as the rivet member (b) in FIG. 3.

The side wall 20 of the circular recess 18 is shown to be vertical in FIGS. 1 and 2, but it may be inclined or curved in cross section instead.

The peripheral land portion surrounding the circular recess 18 of the inner side 14 of the flange may have a singular or a plurality of protrusions of any desired end contour (not shown), either at regular intervals or at random along the periphery of the flange. Those protrusions may take any desired shape, such as annular ones extending circumferentially along the flange or extending diametrally or radially from the flange or independent protuberances disposed in a desired direction.

These protrusions permit the rivet member and the burr member of the invention to be more securely fastened to a sheet material than the conventional members not provided with the circular recess 18, particularly when the material 11 to be riveted is thin, because the circular recess 18 has already reduced the gaps between the sheet material and the inner sides of the flanges of the members according to the invention.

A rivet member is provided which extremely reduces the large gaps that usually result from fastening conventional rivet members to thin sheet materials and hence minimizes the danger of those gaps catching other sheet material portion, string or the like.

Also, a rivet member formed with a protrusion or protrusions on the inner side of its flange is provided which achieves a remarkable improvement in the clinching of the rivet member and the burr member to a sheet material over the performance of conventional equivalents.

What is claimed is:

1. A rivet member comprising a flange part (12) and a shank part (16) protruding upright from the flange part, with a circular recess (18) formed on the inner side (14) of the flange.

2. A rivet member according to claim 1, which is used in combination with a burr member (5, 5′, or 7) having a barrel (13, 13′, or 15) of a desired shape, the circular recess (18) being adapted to receive the barrel that has pierced through a fabric or other sheet material (11) or the barrel with the sheet material interposed between the bottom of barrel and the flange of the sheet.

3. A rivet member according to claim 1, wherein the flange part (12) and the shank part (16) are formed in one piece.

4. A rivet member according to claim 2, wherein the flange part (12) and the shank part (16) are formed in one piece.

5. A rivet member according to any of claims 1 to 4 wherein the circular recess (18) is formed with a single or a plurality of protrusions along the outer circumference of the recess on the inner side (14) of the flange.
